(19) United States
(12) Patent Application Publication
(10) Pub. No.: US 2009/0223369 A1
(43) Pub. Date: Sep. 10, 2009

(54) GAS CHROMATOGRAPH

(75) Inventors: Hideyuki UEGAKI, Kyoto-shi (JP); Masanao FURUKAWA, Takaishi-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 12/368,656

(22) Filed: Feb. 10, 2009

(30) Foreign Application Priority Data
Mar. 7, 2008 (JP) 2008-057109

(51) Int. Cl. B01D 53/02

(52) U.S. Cl. 96/102

(57) ABSTRACT

Disclosed is a gas chromatograph, which comprises a column oven which has a ventilation door disposed in an upper portion thereof and a hydrogen gas sensor installed in an upper region of an internal space thereof. Based on a detection signal from the hydrogen gas sensor, a control section determines a concentration of hydrogen gas contained in a gas within the column oven. If the concentration is equal to or greater than a given threshold value, the control section operates to open the ventilation door while cutting off current to be supplied to a heater, and closing a valve to stop supply of hydrogen gas. Thus, in the event of leakage of hydrogen gas, hydrogen gas accumulated within the column oven can be quickly released outside the column oven to avoid a risk of inflaming.

### BACKGROUND OF THE INVENTION

1. Field of the Invention

The present invention relates to a gas chromatograph, and more specifically to a gas chromatograph using a flammable gas such as hydrogen gas, as a carrier gas to be supplied to a column or a make-up gas to be fed to a detector.

2. Description of the Related Art

In a gas chromatograph, a sample to be analyzed is introduced into a separation column by means of a carrier gas. As the carrier gas, helium is used in many cases. The reason is that helium is excellent in column performance called “theoretical plate number”, i.e., distribution efficiency, or stable, as compared with other gases, such as nitrogen and argon. Although hydrogen gas is excellent in theoretical plate number as with helium, the use of hydrogen gas has been generally avoided, due to a high risk of explosion caused by exceeding over an explosion limit concentration thereof in air. However, there exists a concern about depletion of helium resources, and helium tends to go up in price. Therefore, there is a strong need for using hydrogen gas as the carrier gas, particularly in terms of a running cost of analysis.

As a basis for meeting such a need, it is essential to provide a technique of improving safety in the event of leakage of hydrogen to be supplied as the carrier gas. For example, JP 05-346424A discloses a gas chromatograph designed such that nitrogen gas taken out of a nitrogen-gas separation unit is supplied to a column oven to purge air within the column oven by the nitrogen gas, and hydrogen contained in a gas collected from within the column oven is detected by a hydrogen gas sensor, wherein a hydrogen generation unit for supplying hydrogen as a carrier gas is stopped when hydrogen gas leakage is detected.

A flow rate of gas to be sucked from within the column oven is restricted by the air pump performance. Thus, if a concentration of hydrogen gas within the column oven is sharply increased due, for example, to disconnection in a connection portion between a column and a sample-vaporizing chamber or between the column and a detector, the detection of hydrogen gas leakage is likely to delay. Moreover, even if the supply of hydrogen gas is stopped, it takes a certain time until the concentration of hydrogen gas within the column oven is lowered, because the column oven originally has high gas-tightness. Thus, this technique is not exactly satisfactory measure for safety.

In addition to use as the carrier gas, hydrogen gas is used as a make-up gas for a hydrogen flame ionization detector or the like. In this case, if a pipeline for the make-up gas is arranged within the column oven, the same problems as described above will occur. Moreover, in a rare case, a flammable gas other than hydrogen gas, such as methane gas, is used as the carrier gas and the make-up gas, in the form of mixture with other gas (e.g., argon gas). In this case, the same problems as described above are likely to occur.

### SUMMARY OF THE INVENTION

In view of the above problems, it is an object of the present invention to provide a gas chromatograph capable of improving safety when a flammable gas, such as hydrogen gas, is used as a carrier gas or a make-up gas.

In order to achieve this object, according to a first aspect of the present invention, there is provided a gas chromatograph using a flammable gas, as at least one of a carrier gas for separation of components of a sample and a make-up gas for detection of the components. The gas chromatograph comprises a) a column oven provided with an openable/closable ventilation door and adapted to be substantially hermetically sealed when the ventilation door in a closed position, b) gas detection means operable to detect a flammable gas contained in a gas within the column oven, and c) control means operable, when the gas detection means detects the presence of the flammable gas, to open the ventilation door.

In order to achieve the above object, according to a second aspect of the present invention, there is provided a gas chromatograph using a flammable gas, as at least one of a carrier gas for separation of components of a sample and a make-up gas for detection of the components. The gas chromatograph comprises a) a column oven substantially hermetically sealed and provided with a heater, b) gas detection means operable to detect a flammable gas contained in a gas within the column oven, and c) control means operable, when the gas detection means detects the presence of the flammable gas, to stop a heating operation of the heater.

In the gas chromatograph according to the first aspect of the present invention, the gas detection means is operable to detect a concentration of a flammable gas contained in a gas within the column oven, and the control means is operable, when the detected concentration is equal to or greater than a given threshold value, to determine that the flammable gas is present. In the event of leakage of the flammable gas within the column oven, the control means is operable to open the ventilation door, immediately after recognizing the presence of the flammable gas. Thus, the flammable gas within the column oven is discharged outside the column oven so as to avoid a risk of ignition or inflaming.

Hydrogen gas has a low specific gravity, as is commonly known, and is thereby apt to accumulate in an upper region of an internal space of the column oven. Thus, in cases where the flammable gas is hydrogen gas, the ventilation door is preferably disposed in an upper portion of the column oven. Thus, when the ventilation door is opened, hydrogen gas accumulated within the column oven can be quickly released outside the column oven.

In the gas chromatograph according to the second aspect of the present invention, the gas detection means is operable to detect a concentration of a flammable gas contained in a gas within the column oven, and the control means is operable, when the detected concentration is equal to or greater than a given threshold value, to determine that the flammable gas is present, as with the gas chromatograph according to the first aspect of the present invention. In the event of leakage of the flammable gas within the column oven, the control means is operable to cut off current to be supplied to the heater to heat the column oven, immediately after recognizing the presence of the flammable gas. Thus, an internal temperature of the column oven is lowered so as to avoid a risk of ignition or inflaming. However, even if the current to be supplied to the heater is cut off, the internal temperature of the column oven is not always lowered quickly immediately after the cutoff. Thus, the feature in the second aspect of the present invention is preferably used in combination with the feature in the first aspect of the present invention.

Further, for the aforementioned reason, in cases where the flammable gas is hydrogen gas, the gas detection means is preferably installed in an upper region of an internal space of the column oven. Thus, hydrogen gas leaked within the column oven can be detected quickly and reliably, to promptly take measures in such a manner as to open the ventilation door and/or stop the heating operation of the heater. Additionally, in conjunction with the above measures, the supply of hydrogen gas as the carrier gas and the make-up gas is preferably stopped.

Preferably, the gas chromatograph according to the first or second aspect of the present invention further comprises alarm means operable, when the gas detection means detects the presence of the flammable gas, to give an alarm to a user.

This makes it possible to call user's attention to leakage of the flammable gas, and prompt the user to promptly find out a root cause of the gas leakage, such as disconnection or looseness in a connection portion between a column and a sample-vaporizing chamber, or degradation of a sealing member.

### BRIEF DESCRIPTION OF THE DRAWINGS

FIG. 1 is a front external view of a gas chromatograph according to one exemplary embodiment of the present invention.

FIG. 2 is a schematic block diagram of the gas chromatograph according to the embodiment.

### DESCRIPTION OF THE EXEMPLARY EMBODIMENTS

With reference to accompanying drawings, the present invention will now be described based on a gas chromatograph according to one exemplary embodiment thereof.

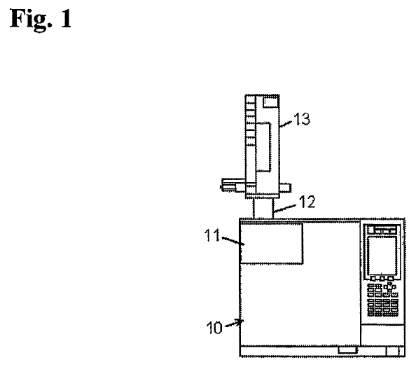

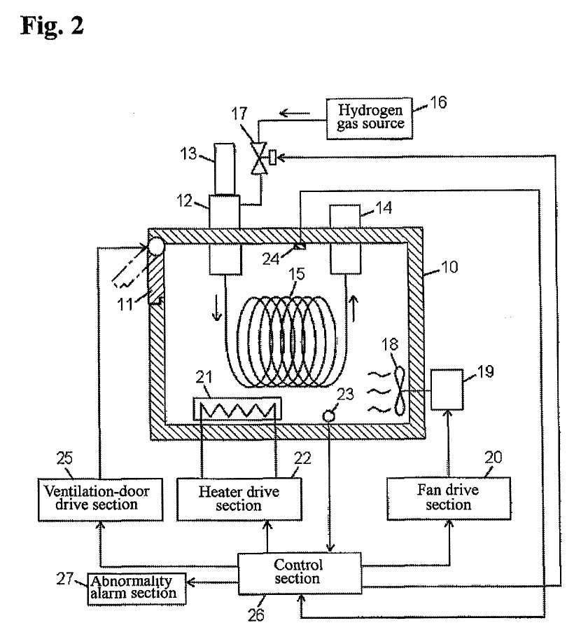

FIG. 1 is a front external view of the gas chromatograph according to this embodiment, and FIG. 2 is a schematic block diagram of the gas chromatograph in FIG. 1.

The gas chromatograph according to this embodiment comprises a hermetically-sealable, box-shaped column oven 10 having a ventilation door 11 which is disposed in an upper potion of a front wall thereof and adapted to be selectively opened and closed according to driving of a ventilation-door drive section 25. A sample-vaporizing chamber 12 and a detector 14 are attached to a top wall of the column oven 10, and an injector 13 is installed in an upper portion of the sample-vaporizing chamber 12. A column 15 is entirely received in an internal space of the column oven 10, in such a manner that opposite ends thereof are connected to respective ones of the sample-vaporizing chamber 12 and the detector 14. Hydrogen gas as a carrier gas is supplied from a hydrogen supply source 16 to the sample-vaporizing chamber 12 through a valve 17.

The column oven 10 houses a blower fan 18, a heating heater 21, a temperature sensor 23 and a hydrogen sensor 24. The blower fan 18 is adapted to drivenly rotated by a motor 19 which is supplied with a driving current from a fan drive section 20. The heater 21 is supplied with a heating current from a heater drive section 22. The hydrogen sensor 24 is designed to detect a concentration of hydrogen gas contained in a gas within the column oven 10, and is installed in an upper portion (in this embodiment, on an inner surface of the top wall) of the column oven 10.

A control section 26 is primarily composed of a microcomputer including a CPU, a RAM and a ROM, and operable, based on detection signals received from the hydrogen gas sensor 24 and the temperature sensor 23, to control the fan drive section 20, the heater drive section 22, the ventilation-door drive section 25 and the valve 17, according to need, and send a signal to an abnormality alarm section to generate an abnormality alarm. The abnormality alarm may be performed by means of lighting of an alarm lamp or sounding of a buzzer.

The ventilation door 11 may be selectively opened and closed according to a movement of a driving source, such as a motor, provided in the ventilation-door drive section 25. Alternatively, the ventilation door 11 may be biased in an open direction by a bias member, such as a spring, wherein, in a normal state, the ventilation door 11 is locked in such a manner as to be maintained in a closed position against a biasing force of the bias member, and then, when the locked state is released according to a driving force of the ventilation-door drive section 25, the ventilation door 11 is automatically opened according to the biasing force.

In an operation of performing analysis using the gas chromatograph according this embodiment, the valve 17 is opened to feed hydrogen gas to the sample-vaporizing chamber 12 at an approximately constant flow rate. When hydrogen gas is used as the carrier gas, the flow rate is typically set at about 100 [mL/min]. The hydrogen gas flows through the column 15, and reaches the detector 14. When a small amount of sample solution is injected from the injector 13 into the sample-vaporizing chamber 12 at a given timing, the sample solution is vaporized within a short period of time, and the vaporized sample is fed into the column 15 with a stream of the hydrogen gas. Various sample components contained in the sample solution are separated from each other in a temporal direction, while passing through the column 15 with the hydrogen gas stream Thus, the sample components reach the detector 14 with a time difference, and the detector 14 detects each of the sample components,

During the above analysis, the column oven 10 is generally heated to increase an internal temperature thereof according to a given temperature rise profile (analysis at elevated temperature), although there are some cases where the internal temperature is maintained at a given constant value (analysis at constant temperature).

For example, if a connection portion between the column 15 and each of the sample-vaporizing chamber 12 and the detector 14 has looseness or insufficient sealing, hydrogen gas as the carrier gas leaks into the column oven 10. It is generally described that an explosion limit concentration of hydrogen gas is about 4%. From this standpoint, in the gas chromatograph according to this embodiment, as measures against hydrogen gas leakage, the following control is executed. The control section 26 monitors the concentration of hydrogen gas bases on a detection signal from the hydrogen gas sensor 24, constantly or at least in a period when the valve 17 is opened. In this operation, an abnormal increase in the concentration of hydrogen gas can be detected accurately and quickly, because the hydrogen gas sensor 24 is installed in the upper region of the internal space of the column oven 10 where the concentration of hydrogen is apt to become higher, as mentioned above.

The control section 26 determines whether the concentration of hydrogen gas is 1% or more which is a value set in consideration of a safety factor, a detection error, etc.,. If it is determined that the concentration of hydrogen gas is 1% or more, the control section 26 instructs the ventilation-door drive section 25 to open the ventilation door 11. Thus, hydrogen gas filled in the column oven 10 is discharged outside the column oven 10. In this operation, the hydrogen gas can be discharged outside the column oven 10 quickly immediately after the ventilation door 11 is opened, because the ventilation door 11 is disposed in the upper portion of the column oven 11, in view of the fact that hydrogen gas having a low specific gravity is apt to accumulate in a relatively upper region of the internal space of the column oven 10, as mentioned above.

The control section 26 also instructs the heater drive section 22 to cut off current to be supplied to the heater 21. Thus, the internal temperature of the column oven 10 is lowered to avoid a risk of inflaming. Further, the control section 26 operates to close the valve 17 to stop the supply of hydrogen gas to the sample-vaporizing chamber 12 and the column 15. Additionally, a rotational speed of the fan 18 may be controllably increased to increase a volume of airstream in order to accelerate the discharge of the hydrogen gas accumulated within the column oven 10.

In order to inform a user of danger, the control section 26 further instructs an abnormality alarm section 27 to generate an abnormality alarm. For example, the abnormality alarm may be performed by displaying the following alarm text: “Hydrogen gas is leaking. Cut off supply gas.”, or may be performed by means of lighting of a danger-indicator lamp, such as a red lamp, or sounding of a buzzer.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

For example, the above embodiment is one example where hydrogen gas is used as the carrier gas. The present invention may also be applied to a gas chromatograph comprising a detector, such as a hydrogen flame ionization detector, which requires a make-up gas, wherein hydrogen gas is used as the make-up gas, and a pipeline for the hydrogen gas is arranged within a column oven. Further, the present invention may be applied even if a flammable gas other than hydrogen gas is used as the carrier gas and/or make-up gas. In this case, if the flammable gas is heavier than air, it is desirable that the position of each of the ventilation door and the hydrogen gas sensor is changed to a lower portion (or a lower region of the internal space) of the column oven.

What is claimed is:

1. A gas chromatograph using a flammable gas, as at least one of a carrier gas for separation of components of a sample and a make-up gas for detection of the components, comprising:
a) a column oven provided with an openable/closable ventilation door and adapted to be substantially hermetically sealed when the ventilation door is in a closed position;
b) gas detection means operable to detect a flammable gas contained in a gas within the column oven; and
c) control means operable, when the gas detection means detects the presence of the flammable gas, to open the ventilation door.

2. The gas chromatograph as defined in claim 1, wherein:
the flammable gas is hydrogen gas; and
the ventilation door is disposed in an upper portion of the column oven.

3. A gas chromatograph using a flammable gas, as at least one of a carrier gas for separation of components of a sample and a make-up gas for detection of the components, comprising:
a) a column oven substantially hermetically sealed and provided with a heater;
b) gas detection means operable to detect a flammable gas contained in a gas within the column oven; and
c) control means operable, when the gas detection means detects the presence of the flammable gas, to stop a heating operation of the heater.

4. The gas chromatograph as defined in claim 1, wherein:
the flammable gas is hydrogen gas; and
the gas detection means is installed in an upper region of an internal space of the column oven.

5. The gas chromatograph as defined in claim 1, which further comprises alarm means operable, when the gas detection means detects the presence of the flammable gas, to give an alarm to a user.

6. The gas chromatograph as defined in claim 2, wherein:
the flammable gas is hydrogen gas; and
the gas detection means is installed in an upper region of an internal space of the column oven.

7. The gas chromatograph as defined in claim 3, wherein:
the flammable gas is hydrogen gas; and
the gas detection means is installed in an upper region of an internal space of the column oven.

8. The gas chromatograph as defined in claim 2, which further comprises alarm means operable, when the gas detection means detects the presence of the flammable gas, to give an alarm to a user.

9. The gas chromatograph as defined in claim 3, which further comprises alarm means operable, when the gas detection means detects the presence of the flammable gas, to give an alarm to a user.

10. The gas chromatograph as defined in claim 4, which further comprises alarm means operable, when the gas detection means detects the presence of the flammable gas, to give an alarm to a user.

11. The gas chromatograph as defined in claim 6, which further comprises alarm means operable, when the gas detection means detects the presence of the flammable gas, to give an alarm to a user.

12. The gas chromatograph as defined in claim 7, which further comprises alarm means operable, when the gas detection means detects the presence of the flammable gas, to give an alarm to a user.
